(19) United States
(12) Patent Application Publication
(10) Pub. No.: US 2026/0368320 A1
(43) Pub. Date: Nov. 19, 2026

(54) ADAPTIVE SIDE-CHANNEL COUNTERMEASURE FOR PROCESSING DEVICES

(71) Applicant: TELEFONAKTIEBOLAGET LM ERICSSON (PUBL), STOCKHOLM (SE)

(72) Inventors: Niklas Lindskog, Lund (SE); Håkan Englund, Lund (SE); Elena Dubrova, Sollentuna (SE)

(21) Appl. No.: 19/121,081

(22) PCT Filed: Oct. 16, 2023
(86) PCT No.: PCT/IB2023/060419

§ 371 Date: Apr. 14, 2025

Related U.S. Application Data
(60) Provisional application No. 63/416,197, filed on Oct. 14, 2022.

(51) Int. Cl. G06F 21/55

(52) U.S. Cl. CPC G06F 21/556; G06F 2221/034

(57) ABSTRACT

Various embodiments provide for a method and processing device that can employ countermeasures to partially obscure or decrease the signal to noise ratio of side-channel emissions associated with leaky micro-operations (micro-ops). Leaky micro-ops are micro-ops that have been identified as potentially being associated with side channel emissions that can be utilized by a malicious party or device to identify sensitive data. When leaky micro-ops are identified, the countermeasure system can generate or select countermeasure micro-ops and dummy data based on the leaky micro-ops in order to be processed in parallel with the leaky micro-ops to make it harder for the malicious party to identify or determine the sensitive data. The countermeasure micro-ops can be executed in parallel in the same processor elements as normally used for micro-ops, or in other embodiments, be executed in a dedicated countermeasure processor element.

### RELATED APPLICATIONS

This application claims the benefit of provisional patent application Ser. No. 63/416,197, filed Oct. 14, 2022, the disclosure of which is hereby incorporated herein by reference in its entirety.

### TECHNICAL FIELD

The present disclosure relates to adaptive side-channel countermeasures for processing devices in a computing system.

### BACKGROUND

### Side-Channel Analysis (SCA)

Side-channel leakage/emission is defined as a non-intended information channel from a device. The side-channel can consist of e.g., power consumption, electromagnetic (EM) emissions, timing, thermal signatures, sound, and optical emissions. An attacker can utilize these leakages to extract sensitive information from a device, e.g., to extract a key utilized to encrypt information, or to extract weights of deep-learning models which are run on the device in order to clone them, or to deduce information about the (possibly confidential) training data which was used to train them. While the former is an acute problem at present, the latter might become an issue in the future, when Artificial Intelligence (AI) algorithms will be a natural part of many systems.

Side-channel attacks work because there is a correlation between the physical measurements (power consumption, EM emissions, timing, etc.) taken at different points during the computation and the internal state of the processing device. For example, the power consumption can be correlated to the Hamming weight (number of binary ‘1’s) of the current state, or to the Hamming distance between the current and the previous state of the device. Finding this correlation enables the side-channel attacks to deduce the internal state and then extract the related sensitive information, e.g., the secret key of a crypto algorithm.

Side-channel attacks can be several orders of magnitude more effective than the conventional mathematical cryptanalysis and much more practical to mount. They do not require expensive equipment, like invasive physical attacks. Furthermore, with advances in machine learning, a more powerful side-channel attacks emerged. Since machine learning techniques are good at finding correlations in raw data, they enable the adversary to bypass many existing countermeasures and break some protected implementations.

In the past years, many types of side channels have been successfully exploited to break physical implementations of many cryptosystems. Examples include implementations of cryptographic algorithms such as Advanced Encryption Standard (AES) and Post-Quantum Cryptography (PQC)-candidates Saber & CRYSTALS-Kyber. There have also been reports where side-channel attacks were used to steal intellectual property and reverse-engineer neural networks.

### Central Processing Unit (CPU) and Other Processing Units

The first CPUs were so-called scalar processor that could execute at most one single instructions at once. To improve performance, concepts such as pipelining and so-called superscalar processors, appeared commercially in the late 1980′s. These introduce parallelism in different manners, modern CPUs typically incorporate both techniques. At a high level of abstraction, they partition instruction execution into a few discrete steps:

·Fetch (get the instruction from the instruction queue), ·Decode (translate the instruction into actions taken by the processing element) ·Execute (perform the actions in the processing element) Retire/Write-Back (store the result of the actions performed in the processing elements).

Each instruction would travel through these steps and the pipelined approach meant that each step would be occupied by a separate instruction.

Modern processors are much more complex and include both additional steps, parallelism within each step, different processing elements a.k.a. execution units (such as Arithmetic Logic Unit (ALU), Advanced Vector Extensions (AVX), Address Generation Unit (AGU), Load-store units, Floating Point Unit (FPU), etc.) but the concept of fetching, decoding, executing, and retiring is very much alive in modern CPU's.

Every step is now parallelized, so several instructions can be decoded at once in parallel decoder. An instruction may contain several sub-steps, and therefore the instruction may be decoded into several micro-operations (micro-ops). Each of these defines a specific action to be executed in a certain type of processing element.

Another improvement is the so-called Out-of-Order execution, i.e., that instructions may “cut-in-line” if a previous instruction is waiting for data necessary to continue.

The execution order is determined by a scheduler which, depending on the architecture used (Intel, AMD etc.) is either one central component (sometimes called a unified scheduler), several semi-centralized components; each controlling several groups of processing elements, or decentralized, where each group of processing elements has its own scheduler.

### Authorized Side-Channel Monitoring

International Application No. PCT/IB2022/056860 describes a method for side-channel monitoring of a Device-under-Monitoring (DuM) where an external monitor can determine the state of the DuM by observing the side-channel emissions.

Apart from the regular “payload side-channel emissions”, PCT/IB2022/056860 adds deterministic noise to create “combined side-channel emissions”. The aim is for the authorized monitors to know the deterministic noise and thereby be able to extract the payload side-channel emissions, whilst non-authorized monitors cannot. Furthermore, the deterministic noise must not be repeated between sessions as this may enable unauthorized monitors to determine how to filter it out.

The monitor may actively check the status of the DuM by observing the combined side-channel emissions. The DuM utilizes a seed and the shared secret to setup generation of session-unique deterministic noise. The seed is shared with the monitor at startup of the DuM.

Knowing the seed and the secret, the filtering module removes the deterministic noise before the status module uses the payload side-channel emissions to determine the state of the DuM.

### SUMMARY

Various embodiments provide for a method and processing device that can employ countermeasures to partially obscure or decrease the signal to noise ratio of side-channel emissions associated with leaky micro-operations (micro-ops). Leaky micro-ops are micro-ops that have been identified as potentially being associated with side channel emissions that can be utilized by a malicious party or device to identify sensitive data. When leaky micro-ops are identified, the countermeasure system can generate or select countermeasure micro-ops and dummy data based on the leaky micro-ops in order to be processed in parallel with the leaky micro-ops to make it harder for the malicious party to identify or determine the sensitive data. The countermeasure micro-ops can be executed in parallel in the same processor elements as normally used for micro-ops, or in other embodiments, be executed in a dedicated countermeasure processor element.

In an embodiment, a method is provided that is performed by a processing unit for generating side-channel countermeasures to protect sensitive information. The method can include receiving an instruction from an instruction queue; determining that a countermeasure process is to be activated for the instruction. The method can also include generating a set of one or more micro-operations based on the instruction, wherein the set of one or more micro-operations are associated with a first side-channel emission. The method can also include, based on the determining that the countermeasure process is to be activated, selecting a countermeasure set of one or more micro-operations based on the set of one or more micro-operations, wherein the countermeasure set of one or more micro-operations are associated with a second side-channel emission that at least partially obscures the first side-channel emission. The method can also include executing the set of one or more micro-operations and the countermeasure set of one or more micro-operations concurrently.

The method can also include selecting additional sets of countermeasure sets of one or more micro-operations for each set of one or more micro-operations generated in response to receiving subsequent instructions.

The method can also include determining, for a subsequent instruction received from the instruction queue, that the countermeasure process is to be deactivated.

In an embodiment, the set of one or more micro-operations and the countermeasure set of one or more micro-operations are executed on at least one processing element.

In an embodiment, the set of one or more micro-operations and the countermeasure set of one or more micro-operations are executed on at least one processing element and at least one dedicated countermeasure processing element.

In an embodiment, prior to executing the set of one or more micro-operations and the countermeasure set of one or more micro-operations, the method further includes queuing the set of one or more micro-operations and the countermeasure set of one or more micro-operations in respective queues.

In an embodiment, a micro-operation of the countermeasure set of one or more micro-operations comprises an identifier identifying a corresponding micro-operation of the set of one or more micro-operations.

In an embodiment, micro-operations of the countermeasure set of one or more micro-operations comprises an identifier identifying the micro-operations as countermeasure micro-operations.

In an embodiment, the determining that the countermeasure process is to be activated is based on a flag associated with the instruction.

In an embodiment, the determining that the countermeasure process is to be activated is based on one or more of a type of instruction, or pattern of instructions received from the instruction queue.

In an embodiment, the method further includes flagging the set of one or more micro-operations as leaky micro-operations and selecting the countermeasure set of one or more micro-operations for each set of one or more micro-operations that are flagged as leaky micro-operations.

In an embodiment, the countermeasure set of one or more micro-operations are selected from a set of currently scheduled micro-operations.

In an embodiment, the countermeasure set of one or more micro-operations comprise at least one selected operation on data generated by a number generator.

In an embodiment, the number generator is one or more of a true random number generator, a pseudo-random number generator, a counter, or a physical unclonable function.

In an embodiment, the countermeasure set of one or more micro-operations comprises at least one selected operation on static data from a data storage.

In an embodiment, a processing device can include processing circuitry configured to generate side-channel countermeasures to protect sensitive information, wherein the processing circuitry is configured to receive an instruction from an instruction queue. The processing device can also be configured to determine that a countermeasure process is to be activated for the instruction. The processing device can also be configured to generate a set of one or more micro-operations based on the instruction, wherein the set of one or more micro-operations are associated with a first side-channel emission. The processing device can also be configured to, based on the determination that the countermeasure process is to be activated, select a countermeasure set of one or more micro-operations based on the set of one or more micro-operations, wherein the countermeasure set of one or more micro-operations are associated with a second side-channel emission that at least partially obscures the first side-channel emission. The processing device can also be configured to execute the set of one or more micro-operations and the countermeasure set of one or more micro-operations concurrently.

Employing hardware for side-channel protection makes it possible to create a device-specific countermeasure without modifying the actual software for each device instance. Device-specific countermeasures are necessary for mitigating profiling attacks which first learn a leakage model on one device (fully controlled by the attacker) and then apply the resulting model to a device under attack to extract the sensitive information.

The current processing unit structure can be kept and adding an additional physical or logical component for side-channel protection or alternatively, enhancing one or several components within the processing unit.

An advantage of such an approach is that the additional component may be independent of the type of the processing unit which it protects, i.e., a universal component may be developed and used for many different processing units.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram of a processing unit according to one or more embodiments of the present disclosure;

FIG. 2 illustrates a flow chart of a method for generating side-channel countermeasures to protect sensitive information in a processing unit according to one or more embodiments of the present disclosure;

FIG. 3 shows an example of a communication system in which the processing element can be employed in accordance with some embodiments;

FIG. 4 shows a User Equipment (UE) in accordance with some embodiments; and

FIG. 5 shows a network node 500 in accordance with some embodiments.

### DETAILED DESCRIPTION

The embodiments set forth below represent information to enable those skilled in the art to practice the embodiments and illustrate the best mode of practicing the embodiments.

Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). Side-channel protection is a burden which falls on software developers, many of which may not have expertise in this specific domain. Side-channel weaknesses in a crypto library may affect millions of devices.

An alternative to software side-channel protection is to implement sensitive algorithms in hardware where it is much easier to create specific side-channel countermeasures. However, this is expensive and must often be tailored for one specific algorithm.

International Application No. PCT/IB2022/056860 describes a solution to create side-channel protection using which can be utilized to only allow an authorized party to monitor the side-channel.

However, the goal for said patent application is to protect all instructions executed by the device, e.g., to prevent an attacker from being able to perform reverse engineering of the processes, rather than protecting specific “leaky” instructions.

Certain aspects of the present disclosure and their embodiments may provide solutions to these or other challenges. Systems and methods are disclosed herein which simplify the process of creating side-channel protected software for software developers without modifying the actual software. The present disclosure mainly focuses on physical side-channels (such as power, electromagnetic radiation, etc.).

This is done by incorporating hardware-assisted hiding of side channel leakage. The software developer only needs to mark what regions are sensitive to side-channel leakage (e.g., crypto operations). By marking sections with an “ACTIVATE” and “DEACTIVATE”,-assisted side channel protection is available without the need for expertise in the field.

A physical or logical countermeasure component can be added to a processing unit, such as a Central Processing Unit (CPU), with the goal of making it very difficult for an attacker to extract the data being processed.

The goal of the countermeasure component is to decrease the Signal-to-Noise Ratio (SNR) when performing a leaky instruction. A leaky instruction is one in which there is a risk for data to be exposed when the processor processes the instruction through side-channel leakage. The SNR is decreased by simultaneously executing several other instructions in the processing unit. By using real-looking instruction operating on generated data and thereby distorting the side-channel information, extracting real data becomes more difficult for an attacker.

When instructions are read from the instruction queue, the processing unit looks for the activation instruction. When this instruction is found by the decoder unit, the instructions are transformed into one or more micro-operations (micro-ops), the decoder unit then alerts the countermeasure component and supplies the micro-ops to be protected, henceforth called “leaky micro-ops”.

The leaky micro-op is supplied to the countermeasure unit, which creates a series of “noise micro-ops” or “countermeasure micro-ops” and supplies them to the scheduler.

When the scheduler receives a leaky micro-op, the scheduler selects a series of “noise micro-ops” with bogus data (not related to the data to be protected) to be run concurrently with the micro-op. The leaky micro-op is executed as intended, concurrently with at least one “noise micro-op”.

Depending on the instruction, only some processing elements need to be allocated for noise micro-ops, which gives the possibility to keep good throughput while still ensuring that no sensitive information is leaked.

When the decoder receives a deactivate instruction, the processing unit returns to normal behavior.

Proposed is an apparatus and an accompanying method for a processing unit within a device that adaptively activates side-channel countermeasures upon detecting instructions containing “leaky micro-operations” (i.e., at risk of emitting side-channel leakage).

The processing unit comprises a countermeasure component. Wherein the activation comprises the countermeasure component creating noise operations at least one of tuple of <operation, data>.

The processing unit executes a leaky operation concurrently with at least one noise operation.

The data may be randomly selected or generated, algorithmically generated from a state or a secret, or pre-defined. The data may also be device-dependent, e.g., by utilizing a physical unclonable function (PUF).

The countermeasure component takes the micro-ops from the decoder as input.

The countermeasure component is activated upon any of the following events:
The decoder receiving an explicit activation instruction.
Determining a pre-defined inbound instruction pattern with known leakage.

The countermeasure component may be a separate physical component within a processing unit, a part of the decoder or a part of the scheduler.

Certain embodiments may provide one or more of the following technical advantage(s). A solution is proposed in the present disclosure to move the responsibility for side-channel protection from software to hardware and thereby from software developer to hardware designer/developer/manufacturer.

Employing hardware for side-channel protection makes it possible to create a device-specific countermeasure without modifying the actual software for each device instance. Device-specific countermeasures are necessary for mitigating profiling attacks which first learn a leakage model on one device (fully controlled by the attacker) and then apply the resulting model to a device under attack to extract the sensitive information.

The current processing unit structure can be kept and adding an additional physical or logical component for side-channel protection or alternatively, enhancing one or several components within the processing unit.

An advantage of such an approach is that the additional component may be independent of the type of the processing unit which it protects, i.e., a universal component may be developed and used for many different processing units.

Methods and systems are disclosed herein to provide a countermeasure system to partially obscure or decrease the signal to noise ratio of side-channel emissions associated with leaky micro-operations (micro-ops). Leaky micro-ops are micro-ops that have been identified as potentially being associated with side channel emissions that can be utilized by a malicious party or device to identify sensitive data. When leaky micro-ops are identified, the countermeasure system can generate or select countermeasure micro-ops and dummy data based on the leaky micro-ops in order to be processed in parallel with the leaky micro-ops to make it harder for the malicious party to identify or determine the sensitive data. The countermeasure micro-ops can be executed in parallel in the same processor elements as normally used for micro-ops, or in other embodiments, be executed in a dedicated countermeasure processor element.

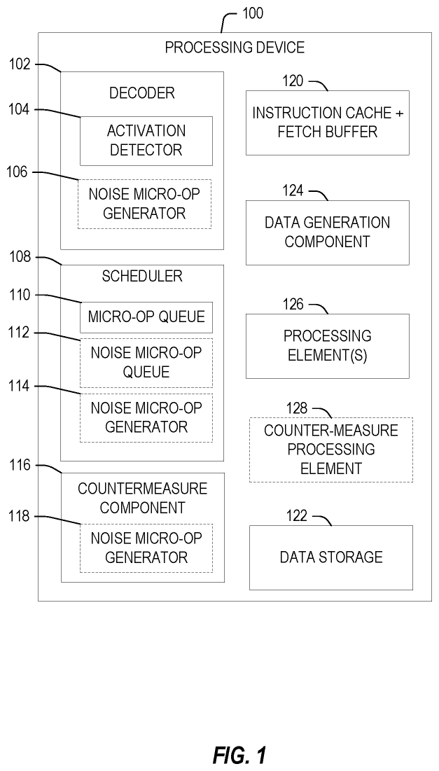

In the main embodiment, the present disclosure will be described in the context of a processing device 100 as depicted in FIG. 1. It should be noted however that the countermeasure proposed could be utilized for any processing unit which has the possibility of simultaneously executing instructions, such as a CPU, Graphic Processing Unit (GPU), microprocessor, etc. These may be present in any processing device such as a server, user equipment device, base station device, network node and the like.

The processing device 100 includes at least one decoder 102 that includes an activation detector 104 and optionally a noise micro-op generator 106. The processing device 100 can also include at least one scheduler 108 that includes a micro-op queue 110, and optionally, a noise micro-op queue 112, and a noise micro-op generator 114. The processing device 100 also includes a countermeasure component 116 that can optionally include a noise micro-op generator 118. In some embodiments the countermeasure component is implemented as a part of the decoder 102 or the scheduler 108. The processing device (100) can also include an instruction cache/fetch buffer 120, a data generation component 124, a data storage (such as a cache or memory) 122, one or more processing elements 126, and optionally, a dedicated countermeasure processing element 128.

In an embodiment, instructions to be processed by the processing device 100 can include a special countermeasure activation instruction which can be issued by the software developer. This may be an instruction which correlates to a line of code or a PRAGMA which is understood by the compiler. In other words, the programmer may indicate sections of the code which are sensitive and thereby require the countermeasure process to be invoked and/or activated. The indications can invoke the countermeasure process can come in the form of instructions to activate or deactivate. The indications can be also be in the form of tags or labels “ACTIVATE” and “DEACTIVATE”, where an ACTIVATE label indicates that the instructions the follow the label are sensitive, and that the processing device should take countermeasures to decrease the signal to noise ratio of the side channel emissions, and where a DEACTIVATE label indicates that the processing device can cease performing the countermeasures to obscure the side channel emissions for the current and subsequent instructions.

The processing device 100 of the present disclosure has one additional component compared to a conventional design and that is the countermeasure component 116 which takes input from the decoder 102 and provides output to the scheduler 108.

The decoder 102 and the scheduler 108 may also have some additional logic compared to their current implementations (e.g., the activation detector 104, noise micro-op generators 106 and 114, and the noise micro-op queue 112).

The decoder 102, or rather the activation detector 104 can monitor for an ACTIVATE instruction for instructions received from the instruction cache 120 and can, in the presence of such, decode the incoming instructions differently than it does when such an instruction is not received.

The scheduler 108 has a separate queue 112 for noise micro-ops and/or an indicator to distinguish noise micro-ops from regular micro-ops.

The present disclosure and the countermeasure system provided herein can be described in three phases: a monitoring phase, a countermeasure selection phase and a countermeasure deployment phase.

During the monitoring phase, the decoder 102 translates instructions in the instruction cache/fetch buffer. If no indication to activate is received, it simply translates these into its regular micro-ops to be scheduled by the scheduler 108, placed in the micro-op queue 110 to be executed by processing elements 126. However, if an indication to activate arrives at the decoder 102, the activation detector 104 can raise a flag noticed by both the countermeasure component 116 and the other decode components.

The decoder 102 can translates all instructions arriving after the indication to activate to special micro-ops, requiring the same basic operation, but now being marked as a “leaky micro-op.” This indicator may be a different micro-op code, a flag in the micro-op or a pre-amble micro-op which indicates all subsequent micro-ops as leaky.

It should be noted that a micro-op can be anything which can be processed by a processing element 126 within the processing device (100). Some instructions may be translated to a single micro-op while other may contain several. A single micro-op may also contain one or several different actions to be performed by the processing element 126.

If an instruction contains a micro-op which is known to not leak any information, this specific micro-op may be flagged and/or marked as a normal micro-op, i.e., not be marked as leaky.

The countermeasure component 116 and scheduler 108 can receive the leaky micro-ops which marks the end of the monitoring phase.

In the countermeasure selection phase, the countermeasure component 116 selects one or more countermeasures which are appropriate to create noise for the leaky micro-op. This may be done in lookup table manner, i.e., predefined micro-ops. For example, if several processing elements can execute the same instruction as the leaky micro-op, this may be a good fit for the “noise micro-ops”.

The countermeasure component 116 further has access to a data generation component 124. The data generation component 124 can comprise one or more of a true random number generator (TRNG), a pseudo-random number generator (PRNG), a physical unclonable function (PUF), and/or a counter. A PRNG may e.g., take an output from a TRNG and/or PUF as seed. It is important that the data generated is available without delay, this puts requirements on the algorithm used to either produce data every clock-cycle or have pre-computed data ready to output. Depending on the instruction, the data may either be placed in a <instruction, data>-tuple, be read from or be written to memory.

If the leaky micro-op includes collecting data from memory, the noise micro-op can also collect data from memory. It generally not possible to detect if the data for the leaky micro-op will be available in the data storage 122, which means that the execution time is not known beforehand. Noisy micro-ops may be selected to produce noise for the worst-case execution time scenario.

In an embodiment, the scheduler 108 can distinguish the noise micro-ops from regular micro-ops. This can be implemented using a separate queue (e.g., leaky micro-ops are queued in the micro-op queue 110 while noise or countermeasure micro-ops are queued in the noise micro-op queue 112), a bit set in the micro-op or a special instruction code. Another logistic challenge is to identify the noise micro-ops belonging to a specific leaky micro-op. In some implementations, where the same type of micro-op is used as noise micro-op, this is easily solved. In other implementations, an identifier indicating which type of micro-op it is intended for may be used for the noise micro-ops. The corresponding noise micro-op for each respective leaky micro-op may thus be identified.

The countermeasure component 116 supplies the created instructions and/or noise/countermeasure micro-ops to the scheduler 108, and this marks the end of the countermeasure selection phase.

During the countermeasure deployment phase, the scheduler 108 is responsible for executing the leaky micro-op concurrently with the noisy micro-ops. This is done by selecting the leaky micro-op from the regular queue 110 and selecting the appropriate noise micro-ops from the queue. As mentioned previously, this may either be a separate queue (e.g., noise micro-op queue 112), or the instructions may be in the same queue 110 and marked to indicate that they are noise micro-ops.

The scheduler 108 may await all needed processing elements to be ready to execute to ensure all executions are happening simultaneously.

These three phases continue for each receives instruction until a DEACTIVATE instruction is received by the decoder 102, after which no more incoming instructions will be translated to leaky micro-ops.

In one embodiment, the processing device 100 is equipped with a dedicated countermeasure processing element 128. This may be an element having very distinct power consumption characteristics and fast switching in hamming distances of the data it holds. By using a dedicated element, the goal to create a side-channel leakage which is very difficult to extract information from, becomes easier.

In one embodiment, explicit indications to activate or deactivate the countermeasure process are not included. Instead, leaky micro-ops are determined by the countermeasure component 116 by monitoring patterns in the incoming instructions from the instruction cache 120. For example, certain instruction patterns indicative of cryptological algorithms could be used as activation mechanism and after X repeats of said pattern, corresponding to the number of rounds in the crypto algorithm it may be deactivated.

In one embodiment, the countermeasure component 116 is implemented within the decoder 102 via the noise micro-op generator 106. This allows the noise micro-ops to be selected directly in the decoding process by the noise micro-op generator 106. I.e., when ACTIVATE has been received, an instruction which is known to contain leaky micro-ops is automatically decoded to also include noise micro-ops. The disadvantage being that in designs with several decoders, it may require each of the decoders to have such a construction rather than one centralized component.

In a related embodiment, the countermeasure component 116 is implemented within the scheduler 108 via the noise micro-op generator 114 and thereby making it easier to create noise micro-ops when needed. Furthermore, the scheduler 108 could handle the mapping between noise micro-ops and leaky micro-ops internally, this is conceptually similar to so called fused micro-ops. A fused micro-operation may be generated by decoders and count as one micro-operation until the execution stage, where it is split into several micro-ops. The disadvantage being that in designs with several schedulers, it may require each of the schedulers to have such a construction rather than one centralized component.

In one embodiment, the scheduler 108 does not have access to more than one processing element 126. In this case, the scheduler 108 may merge a leaky micro-op and a noise micro-op of the same kind, using an associative and invertible operation (e.g., XOR) on the data to be processed. I.e., the “real” data is not processed directly by the leaky micro-op in the CPU. Due to the invertibility of the operation, the operation can be removed afterwards.

This, of course, requires a different micro-op to perform the associative and invertible operation, but as long as this operation does not have significant side-channel leakage, it is still a beneficial as countermeasure.

In one embodiment, related to the embodiment described above, the scheduler may await currently scheduled and/or regular micro-ops fitting to create noise for a leaky micro-op and run these concurrently. In this way, noise or countermeasure micro-ops do not need to be generated, but waiting for appropriate regular micro-ops to obscure the leaky micro-ops may delay the execution of the leaky micro-op as the scheduler 108 does not control the inflow of micro-ops.

In one embodiment, instead of, or in addition to, generating data for the micro-ops, static data is used, such data may be defined in the hardware, or stored in memory. This may be an alternative where the execution time does not allow to wait for the generation of random / pseudo random data.

In one embodiment, the scheduler 108 may further deploy several noise micro-ops sequentially to ensure that the leaky micro-op is executed simultaneously to at least one noise micro-op. This has the benefit that is reduces the concurrency demands for the scheduler 108. However, it requires more additional clock cycles for the noise micro-ops to execute, thereby lowering throughput in these processing elements.

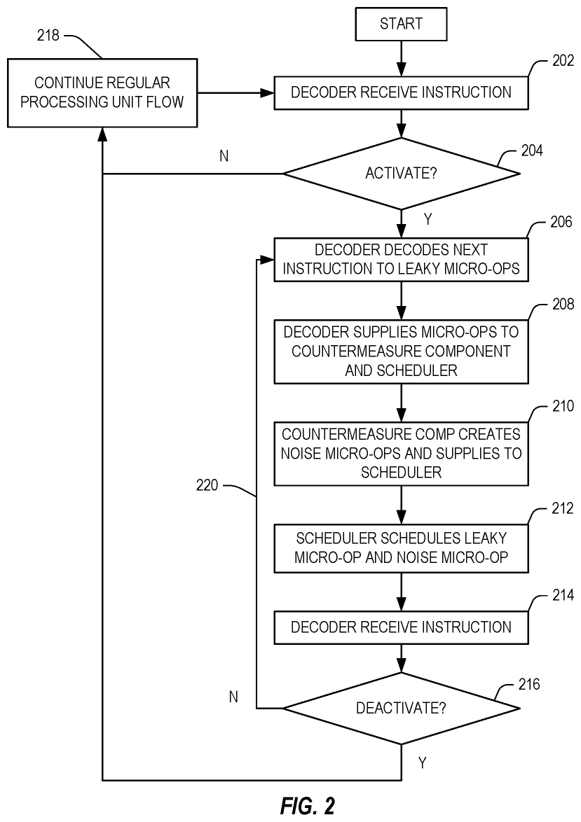

FIG. 2 illustrates a flow chart for generating side-channel countermeasures to protect sensitive information in a processing device 100.

At step 202, the decoder 102 receives an instruction from an instruction queue or cache 120.

The activation detector 104 can determine whether the instruction is an ACTIVATE instruction flagged at step 204 or if it already activated. In some embodiments, the instruction may not have an explicit indicator indicating that the countermeasure process is to be activated, but instead the activation detector 104 can determine that the countermeasure process is to be activated is based on one or more of a type of instruction, or pattern of instructions received from the instruction queue 120. If the activation detector does not determine that the countermeasure process is to be activated, the instruction is processed according to the regular flow at step 218.

On the other hand, if the countermeasure process is to be activated, the decoder 102 generates at step 206 a set of one or more micro-operations based on the instruction, wherein the set of one or more micro-operations are associated with a first side-channel emission.

At step 208, the decoder 102 can supply the leaky micro-ops to both the scheduler 108 and the countermeasure component 116. The scheduler component 108 can then add the leaky micro-ops to a micro-ops queue 110.

At step 210, the countermeasure component 116 can select a countermeasure set of one or more micro-operations based on the set of one or more (leaky) micro-operations, wherein the countermeasure set of one or more micro-operations are associated with a second side-channel emission that at least partially obscures the first side-channel emission.

At step 212, the scheduler 108 can schedule the leaky micro-ops and the countermeasure micro-ops to be executed concurrently. The two sets of micro-ops can be executed on the same processing element (e.g., processing element 126) or on separate processing elements 126 and 128.

While the processing element(s) execute the micro-ops, the decoder 102 can receive a new instruction at step 214 and the activation detector 104 can check to see if the new instruction has an ACTIVATE flag or whether the countermeasure process should otherwise be activated at step 216. If there is an ACTIVATE flag or the countermeasure process should otherwise be resumed, the process can repeat at step 220. Alternatively, if an indication to deactivate is received for a subsequent instruction, the countermeasure process can be deactivated after the micro-ops already in the pipeline are executed, and the regular processing flow can resume at step 218.

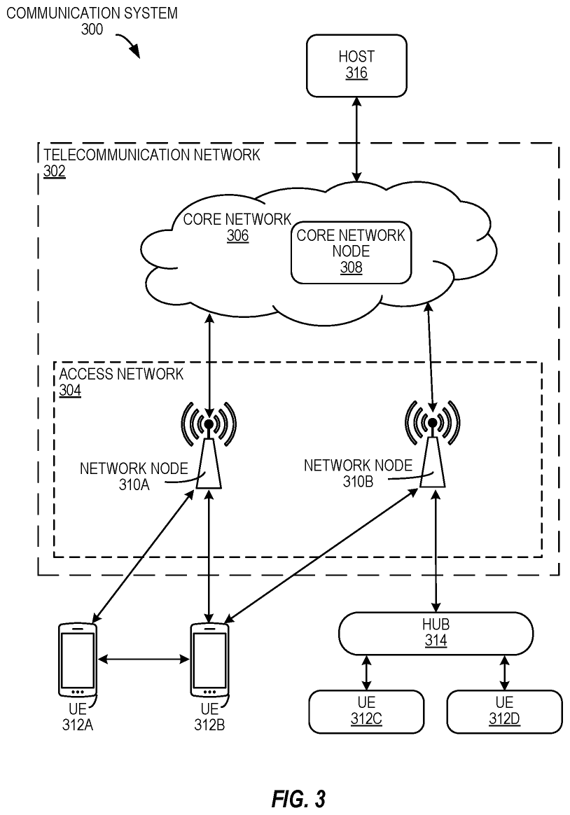

FIG. 3 shows an example of a communication system 300 in which the processing device 100 can be employed in accordance with some embodiments.

In the example, the communication system 300 includes a telecommunication network 302 that includes an access network 304, such as a Radio Access Network (RAN), and a core network 306, which includes one or more core network nodes 308. The access network 304 includes one or more access network nodes, such as network nodes 310A and 310B (one or more of which may be generally referred to as network nodes 310), or any other similar Third Generation Partnership Project (3GPP) access node or non-3GPP Access Point (AP). The network nodes 310 facilitate direct or indirect connection of User Equipment (UE), such as by connecting UEs 312A, 312B, 312C, and 312D (one or more of which may be generally referred to as UEs 312) to the core network 306 over one or more wireless connections. Any of the devices that potentially handle sensitive data, such as any of the devices in the access network 304, the core network 308, or UEs 312 can employ the processing device 100 that generate side-channel countermeasures to protect sensitive information as described above.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The UEs 312 may be any of a wide variety of communication devices, including wireless devices arranged, configured, and/or operable to communicate wirelessly with the network nodes 310 and other communication devices. Similarly, the network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the network nodes 310 to one or more hosts, such as host 316. These connections may be direct or indirect via one or more intermediary networks or devices. In other examples, network nodes may be directly coupled to hosts. The core network 306 includes one more core network nodes (e.g., core network node 308) that are structured with hardware and software components. Features of these components may be substantially similar to those described with respect to the UEs, network nodes, and/or hosts, such that the descriptions thereof are generally applicable to the corresponding components of the core network node 308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 300 of FIG. 3 enables connectivity between the UEs, network nodes, and hosts. In that sense, the communication system 300 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 302 is a cellular network that implements 3GPP standardized features. Accordingly, the telecommunication network 302 may support network slicing to provide different logical networks to different devices that are connected to the telecommunication network 302. For example, the telecommunication network 302 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single-or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 314 communicates with the access network 304 to facilitate indirect communication between one or more UEs (e.g., UE 312C and/or 312D) and network nodes (e.g., network node 310B). In some examples, the hub 314 may be a controller, router, content source and analytics, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs, network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a Virtual Reality (VR) headset, display, loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular in if one or more of the UEs are low energy IoT devices.

The hub 314 may have a constant/persistent or intermittent connection to the network node 310B. The hub 314 may also allow for a different communication scheme and/or schedule between the hub 314 and UEs (e.g., UE 312C and/or 312D), and between the hub 314 and the core network 306. In other examples, the hub 314 is connected to the core network 306 and/or one or more UEs via a wired connection. Moreover, the hub 314 may be configured to connect to a Machine-to-Machine (M2M) service provider over the access network 304 and/or to another UE over a direct connection. In some scenarios, UEs may establish a wireless connection with the network nodes 310 while still connected via the hub 314 via a wired or wireless connection. In some embodiments, the hub 314 may be a dedicated hub-that is, a hub whose primary function is to route communications to/from the UEs from/to the network node 310B. In other embodiments, the hub 314 may be a non-dedicated hub-that is, a device which is capable of operating to route communications between the UEs and the network node 310B, but which is additionally capable of operating as a communication start and/or end point for certain data channels.

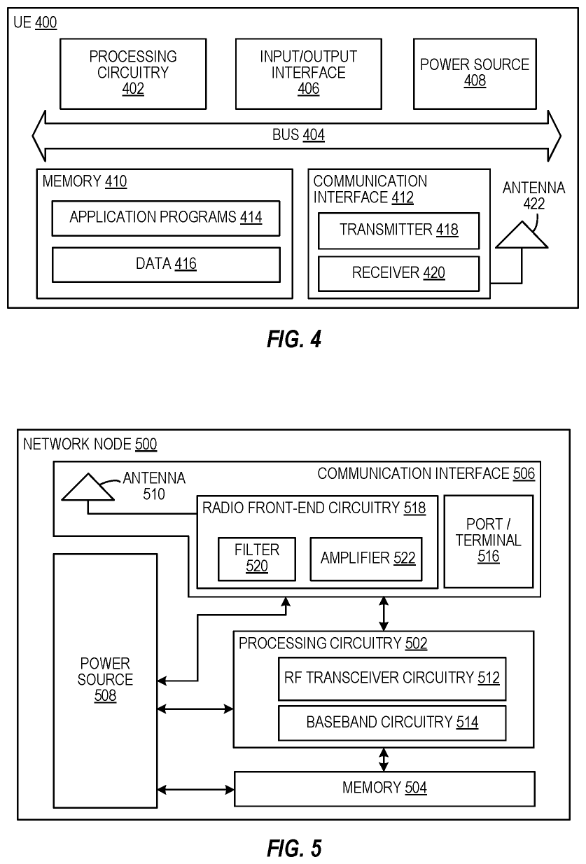

FIG. 4 shows a UE 400 in accordance with some embodiments. The UE 400 can include a processing device 100 as described herein which can perform the method of generating side-channel countermeasures to protect sensitive information as disclosed herein. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 400 includes processing circuitry 402 that is operatively coupled via a bus 404 to an input/output interface 406, a power source 408, memory 410, a communication interface 412, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 402 may include multiple CPUs.

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 408 itself, and/or an external power source, to the various parts of the UE 400 via input circuitry or an interface such as an electrical power cable. Delivering power may be, for example, for charging the power source 408. Power circuitry may perform any formatting, converting, or other modification to the power from the power source 408 to make the power suitable for the respective components of the UE 400 to which power is supplied.

The memory 410 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 410 may allow the UE 400 to access instructions, application programs, and the like stored on transitory or non-transitory memory media, to off-load data, or to upload data. An article of manufacture, such as one utilizing a communication system, may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., the antenna 422) and may share circuit components, software, or firmware, or alternatively be implemented separately.

In the illustrated embodiment, communication functions of the communication interface 412 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 412, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 400 shown in FIG. 4.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 5 shows a network node 500 in accordance with some embodiments. The network node 500 can include a processing device 100 as described herein which can perform the method of generating side-channel countermeasures to protect sensitive information as disclosed herein. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 500 includes processing circuitry 502, memory 504, a communication interface 506, and a power source 508. The network node 500 may be composed of multiple physically separate components (e.g., a Node B component and an RNC component, or a BTS component and a BSC component, etc.), which may each have their own respective components. In certain scenarios in which the network node 500 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 500 may be configured to support multiple RATs. In such embodiments, some components may be duplicated (e.g., separate memory 504 for different RATs) and some components may be reused (e.g., an antenna 510 may be shared by different RATs). The network node 500 may also include multiple sets of the various illustrated components for different wireless technologies integrated into network node 500, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 500.

The processing circuitry 502 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 500 components, such as the memory 504, to provide network node 500 functionality.

In some embodiments, the processing circuitry 502 includes a System on a Chip (SOC). In some embodiments, the processing circuitry 502 includes one or more of Radio Frequency (RF) transceiver circuitry 512 and baseband processing circuitry 514. In some embodiments, the RF transceiver circuitry 512 and the baseband processing circuitry 514 may be on separate chips (or sets of chips), boards, or units, such as radio units and digital units. In alternative embodiments, part or all of the RF transceiver circuitry 512 and the baseband processing circuitry 514 may be on the same chip or set of chips, boards, or units.

The memory 504 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and the memory 504 are integrated.

The communication interface 506 is used in wired or wireless communication of signaling and/or data between a network node, access network, and/or UE. As illustrated, the communication interface 506 comprises port(s)/terminal(s) 516 to send and receive data, for example to and from a network over a wired connection. The communication interface 506 also includes radio front-end circuitry 518 that may be coupled to, or in certain embodiments a part of, the antenna 510. The radio front-end circuitry 518 comprises filters 520 and amplifiers 522. The radio front-end circuitry 518 may be connected to the antenna 510 and the processing circuitry 502. The radio front-end circuitry 518 may be configured to condition signals communicated between the antenna 510 and the processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of the filters 520 and/or the amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface 506 may comprise different components and/or different combinations of components.

In certain alternative embodiments, the network node 500 does not include separate radio front-end circuitry 518; instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes the one or more ports or terminals 516, the radio front-end circuitry 518, and the RF transceiver circuitry 512 as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the network node 500 through an interface or port.

The antenna 510, the communication interface 506, and/or the processing circuitry 502 may be configured to perform any receiving operations and/or certain obtaining operations described herein as being performed by the network node 500. Any information, data, and/or signals may be received from a UE, another network node, and/or any other network equipment. Similarly, the antenna 510, the communication interface 506, and/or the processing circuitry 502 may be configured to perform any transmitting operations described herein as being performed by the network node 500. Any information, data, and/or signals may be transmitted to a UE, another network node, and/or any other network equipment.

The power source 508 provides power to the various components of the network node 500 in a form suitable for the respective components (e.g., at a voltage and current level needed for each respective component). The power source 508 may further comprise, or be coupled to, power management circuitry to supply the components of the network node 500 with power for performing the functionality described herein. For example, the network node 500 may be connectable to an external power source (e.g., the power grid or an electricity outlet) via input circuitry or an interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the network node 500 may include additional components beyond those shown in FIG. 5 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some embodiments of the methods and techniques disclosed herein are as follows:

Embodiment 1: A method performed by a processing unit (100) for generating side-channel countermeasures to protect sensitive information, the method comprising: receiving (202) an instruction from an instruction queue (120); determining (204) that a countermeasure process is to be activated for the instruction; generating (206) a set of one or more micro-operations based on the instruction, wherein the set of one or more micro-operations are associated with a first side-channel emission; based on the determining that the countermeasure process is to be activated, selecting (210) a countermeasure set of one or more micro-operations based on the set of one or more micro-operations, wherein the countermeasure set of one or more micro-operations are associated with a second side-channel emission that at least partially obscures the first side-channel emission; and executing (212) the set of one or more micro-operations and the countermeasure set of one or more micro-operations concurrently.

Embodiment 2: The method of embodiment 1, further comprising selecting (220) additional sets of countermeasure sets of one or more micro-operations for each set of one or more micro-operations generated in response to receiving subsequent instructions.

Embodiment 3: The method of any of embodiments 1-2, further comprising: determining (218), for a subsequent instruction received from the instruction queue (120), that the countermeasure process is to be deactivated.

Embodiment 4: The method of any of embodiments 1-3, wherein the set of one or more micro-operations and the countermeasure set of one or more micro-operations are executed on a at least one processing element (126).

Embodiment 5: The method of any of embodiments 1-3, wherein the set of one or more micro-operations and the countermeasure set of one or more micro-operations are executed on at least one processing element (126) and at least one dedicated countermeasure processing element (128).

Embodiment 6: The method of any of embodiments 1-5, wherein prior to executing the set of one or more micro-operations and the countermeasure set of one or more micro-operations, the method further comprises: queuing (212) the set of one or more micro-operations and the countermeasure set of one or more micro-operations in respective queues (110, 112).

Embodiment 7: The method of any of embodiments 1-6, wherein a micro-operation of the countermeasure set of one or more micro-operations comprises an identifier identifying a corresponding micro-operation of the set of one or more micro-operations.

Embodiment 8: The method of any of embodiments 1-6, wherein micro-operations of the countermeasure set of one or more micro-operations comprises an identifier identifying the micro-operations as countermeasure micro-operations.

Embodiment 9: The method of any of embodiments 1-8, wherein the determining that the countermeasure process is to be activated is based on a flag associated with the instruction.

Embodiment 10: The method of any of embodiments 1-8, wherein the determining that the countermeasure process is to be activated is based on one or more of a type of instruction, or pattern of instructions received from the instruction queue (120).

Embodiment 11: The method of any of embodiments 1-10, further comprising: flagging (208) the set of one or more micro-operations as leaky micro-operations; and selecting (210) the countermeasure set of one or more micro-operations for each set of one or more micro-operations that are flagged as leaky micro-operations.

Embodiment 12: The method of any of embodiments 1-11, wherein the countermeasure set of one or more micro-operations are selected from a set of currently scheduled micro-operations.

Embodiment 13: The method of any of embodiments 1-11, wherein the countermeasure set of one or more micro-operations comprise at least one selected operation on data generated by a number generator.

Embodiment 14: The method of embodiment 13, wherein the number generator is one or more of a true random number generator, a pseudo-random number generator, a counter, or a physical unclonable function.

Embodiment 15: The method of any of embodiments 1-11, wherein the countermeasure set of one or more micro-operations comprises at least one selected operation on static data from a data storage (122).

Embodiment 16: A processing device (100), comprising: processing circuitry configured to generate side-channel countermeasures to protect sensitive information, wherein the processing circuitry is configured to: receive (202) an instruction from an instruction queue (120); determine (204) that a countermeasure process is to be activated for the instruction; generate (206) a set of one or more micro-operations based on the instruction, wherein the set of one or more micro-operations are associated with a first side-channel emission; based on the determination that the countermeasure process is to be activated, select (210) a countermeasure set of one or more micro-operations based on the set of one or more micro-operations, wherein the countermeasure set of one or more micro-operations are associated with a second side-channel emission that at least partially obscures the first side-channel emission; and execute (212) the set of one or more micro-operations and the countermeasure set of one or more micro-operations concurrently.

Embodiment 17: The processing device of embodiment 16, wherein the processing circuitry is further configured to: select (220) additional sets of countermeasure sets of one or more micro-operations for each set of one or more micro-operations generated in response to receiving subsequent instructions.

Embodiment 18: The processing device of any of embodiments 16-17, wherein the processing circuitry is further configured to: determine (218), for a subsequent instruction received from the instruction queue (120), that the countermeasure process is to be deactivated.

Embodiment 19: The processing device of any of embodiments 16-18, wherein the set of one or more micro-operations and the countermeasure set of one or more micro-operations are executed on a single processing element (126).

Embodiment 20: The processing device of any of embodiments 16-18, wherein the set of one or more micro-operations and the countermeasure set of one or more micro-operations are executed on at least one processing element (126) and at least one dedicated countermeasure processing element (128) Embodiment 21: The processing device of any of embodiments 16-20, wherein prior to execution of the set of one or more micro-operations and the countermeasure set of one or more micro-operations, the processing circuitry is further configured to: queue (212) the set of one or more micro-operations and the countermeasure set of one or more micro-operations in respective queues (110, 112).

Embodiment 22: The processing device of any of embodiments 16-21, wherein a micro-operation of the countermeasure set of one or more micro-operations comprises an identifier identifying a corresponding micro-operation of the set of one or more micro-operations.

Embodiment 23: The processing device of any of embodiments 16-21, wherein micro-operations of the countermeasure set of one or more micro-operations comprises an identifier identifying the micro-operations as countermeasure micro-operations.

Embodiment 24: The processing device of any of embodiments 16-23, wherein the determining that the countermeasure process is to be activated is based on a flag associated with the instruction.

Embodiment 25: The processing device of any of embodiments 16-23, wherein the determining that the countermeasure process is to be activated is based on one or more of a type of instruction, or pattern of instructions received from the instruction queue (120).

Embodiment 26: The processing device of any of embodiments 16-25, wherein the processing circuitry is further configured to: flag (208) the set of one or more micro-operations as leaky micro-operations; and select (210) the countermeasure set of one or more micro-operations for each set of one or more micro-operations that are flagged as leaky micro-operations.

Embodiment 27: The processing device of any of embodiments 16-26, wherein the countermeasure set of one or more micro-operations are selected from a set of previously scheduled micro-operations.

Embodiment 28: The processing device of any of embodiments 16-26, wherein the countermeasure set of one or more micro-operations comprise at least one selected operation on data generated by a number generator (124).

Embodiment 29: The processing device of embodiment 28, wherein the number generator (124) is one or more of a true-random number generator, a pseudo-random number generator, a counter, or a physical unclonable function.

Embodiment 30: The processing device of any of embodiments 16-26, wherein the countermeasure set of one or more micro-operations comprises at least one selected operation on static data from a data storage (122).

Those skilled in the art will recognize improvements and modifications to the embodiments of the present disclosure. All such improvements and modifications are considered within the scope of the concepts disclosed herein.

1. A method performed by a processing device for generating side-channel countermeasures to protect sensitive information, the method comprising:
receiving an instruction from an instruction queue;
determining that a countermeasure process is to be activated for the instruction;
generating a set of one or more micro-operations based on the instruction, wherein the set of one or more micro-operations are associated with a first side-channel emission;
based on the determining that the countermeasure process is to be activated, selecting a countermeasure set of one or more micro-operations based on the set of one or more micro-operations, wherein the countermeasure set of one or more micro-operations are associated with a second side-channel emission that at least partially obscures the first side-channel emission; and
executing the set of one or more micro-operations and the countermeasure set of one or more micro-operations concurrently.

2. The method of claim 1, further comprising
selecting additional sets of countermeasure sets of one or more micro-operations for each set of one or more micro-operations generated in response to receiving subsequent instructions.

3. The method of claim 1, further comprising:
determining for a subsequent instruction received from the instruction queue that the countermeasure process is to be deactivated.

4. The method of claim 1, wherein the set of one or more micro-operations and the countermeasure set of one or more micro-operations are executed on at least one processing element.

5. The method of claim 1, wherein the set of one or more micro-operations and the countermeasure set of one or more micro-operations are executed on at least one processing element and at least one dedicated countermeasure processing element.

6. The method of claim 1, wherein prior to executing the set of one or more micro-operations and the countermeasure set of one or more micro-operations, the method further comprises:
queuing the set of one or more micro-operations and the countermeasure set of one or more micro-operations in respective queues.

7. The method of claim 1, wherein a micro-operation of the countermeasure set of one or more micro-operations comprises an identifier identifying a corresponding micro-operation of the set of one or more micro-operations.

8. The method of claim 1, wherein micro-operations of the countermeasure set of one or more micro-operations comprises an identifier identifying the micro-operations as countermeasure micro-operations.

9. The method of claim 1, wherein the determining that the countermeasure process is to be activated is based on a flag associated with the instruction.

10. The method of claim 1, wherein the determining that the countermeasure process is to be activated is based on one or more of a type of instruction, or pattern of instructions received from the instruction queue.

11-15. (canceled)

16. A processing device, comprising:
processing circuitry configured to generate side-channel countermeasures to protect sensitive information, wherein the processing circuitry is configured to:
receive an instruction from an instruction queue;
determine that a countermeasure process is to be activated for the instruction;
generate a set of one or more micro-operations based on the instruction, wherein the set of one or more micro-operations are associated with a first side-channel emission;
based on the determination that the countermeasure process is to be activated, select a countermeasure set of one or more micro-operations based on the set of one or more micro-operations, wherein the countermeasure set of one or more micro-operations are associated with a second side-channel emission that at least partially obscures the first side-channel emission; and
execute the set of one or more micro-operations and the countermeasure set of one or more micro-operations concurrently.

17. The processing device of claim 16, wherein the processing circuitry is further configured to:
select additional sets of countermeasure sets of one or more micro-operations for each set of one or more micro-operations generated in response to receiving subsequent instructions.

18. The processing device of claim 16, wherein the processing circuitry is further configured to:
determine for a subsequent instruction received from the instruction queue that the countermeasure process is to be deactivated.

19. The processing device of claim 16, wherein the set of one or more micro-operations and the countermeasure set of one or more micro-operations are executed on a single processing element.

20. The processing device of claim 16, wherein the set of one or more micro-operations and the countermeasure set of one or more micro-operations are executed on at least one processing element and at least one dedicated countermeasure processing element

21. The processing device of claim 16, wherein prior to execution of the set of one or more micro-operations and the countermeasure set of one or more micro-operations, the processing circuitry is further configured to:
queue the set of one or more micro-operations and the countermeasure set of one or more micro-operations in respective queues (110, 112).

22. The processing device of claim 16, wherein a micro-operation of the countermeasure set of one or more micro-operations comprises an identifier identifying a corresponding micro-operation of the set of one or more micro-operations.

23. The processing device of claim 16, wherein micro-operations of the countermeasure set of one or more micro-operations comprises an identifier identifying the micro-operations as countermeasure micro-operations.

24. The processing device of claim 16, wherein the determining that the countermeasure process is to be activated is based on a flag associated with the instruction.

25. The processing device of claim 16, wherein the determining that the countermeasure process is to be activated is based on one or more of a type of instruction, or pattern of instructions received from the instruction queue.

26-30. (canceled)
